(19) United States
(12) Patent Application Publication
(10) Pub. No.: US 2026/0180736 A1
(43) Pub. Date: Jun. 25, 2026

(54) TERMINAL AND BASE STATION IN COMMUNICATION SYSTEM

(71) Applicant: NTT DOCOMO, INC., Tokyo (JP)

(72) Inventors: Xin Wang, Beijing (CN); Xiaolin Hou, Beijing (CN); Lan Chen, Beijing (CN); Satoshi Suyama, Tokyo (JP); Tatsuki Okuyama, Tokyo (JP)

(73) Assignee: NTT DOCOMO, INC., Tokyo (JP)

(21) Appl. No.: 18/712,612

(22) PCT Filed: Nov. 24, 2021
(86) PCT No.: PCT/CN2021/132923

§ 371 Date: May 22, 2024

(51) Int. Cl. H04L 5/00

(52) U.S. Cl. CPC H04L 5/0048

(57) ABSTRACT

The present disclosure provides a terminal and a base station in a communication system. The terminal includes a receiving unit configured to receive information about spatial filters of a base station; a control unit configured to determine at least one spatial filter index corresponding to a specific synchronization signal block index according to information about the spatial filters of the base station, wherein the at least one spatial filter index corresponding to the specific synchronization signal block index is generated by using a pseudo-random sequence generator.

### TECHNICAL FIELD

The present disclosure relates to a field of wireless communication, and more particularly, to a method performed by a terminal in a communication system, a method performed by a base station in the communication system, and the corresponding terminal and base station.

### BACKGROUND

In order to improve the throughput of a communication system, a multi-antenna technology, such as a Multiple Input Multiple Output (MIMO) technology, is proposed. In a scene where the multi-antenna technology is applied, in order to effectively eliminate the multi-user interference, improve the system capacity, and reduce the difficulty of signal processing for a receiver, a precoding/beam forming technology is proposed at a transmitter side.

In a 5G and wireless communication network system after 5G, the extremely high data rate/capacity is one of its Key Performance Indicators (KPIs). For example, a communication industry predicts that the peak data rate of the wireless communication network system after 5G may reach 1 Tbps. In order to achieve this extremely high data rate/capacity, it is necessary to provide enough MIMO gain/array gain to improve the multiplexing order and signal-to-noise ratio. For this reason, in order to cover a large range of 3D areas, a larger antenna array and a larger number of antennas are needed to provide the gain to support this extremely high data rate/capacity. For example, in order to achieve the peak data rate of 1 Tbps, when a configuration of 20 GHz bandwidth, 12 MIMO layers and 64 Quadrature Amplitude Modulation (QAM) is adopted, a required antenna array size reaches the order of 100,000 subarrays, and the number of corresponding beams reaches the order of tens of thousands.

In the precoding/beam forming technology, the transmitter may transmit multiple beams in different spatial directions, and the receiver can monitor/scan multiple beam transmissions from the transmitter in different receiving spatial directions. The receiver selects the optimal beam by measuring the received power or quality of the Reference Signal (RS) received on each beam, so as to achieve beam alignment between the receiver and the transmitter.

However, with the increase of the number of beams, the RS overhead of the beam alignment between transmitter and receiver in wireless communication network system increases, and the time of beam search/scanning in the process of the beam alignment also increases, which leads to the increase of the time for the receiver to access the transmitter, so there is a need for further improvement of the beam alignment technology.

### SUMMARY

In order to overcome the defects in the prior art, the present disclosure proposes a beam search operation based on hash mapping, so as to reduce the RS overhead and shorten the time for the terminal to access the base station, thereby improving the performance of the communication system. The disclosure also proposes a method performed by the terminal, a method performed by the base station, and the corresponding terminal and base station in this scene, so as to reduce the RS overhead and further improve the performance of the communication system.

According to an aspect of the present disclosure, there is provided a method performed by a terminal in a communication system, including: receiving information about spatial filters of a base station; and determining at least one spatial filter index corresponding to a specific synchronization signal block index according to information about the spatial filters of the base station, wherein the at least one spatial filter index corresponding to the specific synchronization signal block index is generated by using a pseudo-random sequence generator.

According to an example of the present disclosure, wherein the information about the spatial filters of the base station includes information about an index of a synchronization signal block burst set associated with the spatial filters of the base station and information about indexes of synchronization signal blocks in the synchronization signal block burst set, wherein one synchronization signal block burst set includes a plurality of synchronization signal blocks.

According to an example of the present disclosure, the method further includes receiving information about a system frame number; and determining the information about the index of the synchronization signal block burst set according to at least a part of bits in the information about the system frame number.

According to an example of the present disclosure, wherein the information about the spatial filters of the base station further includes at least one of information about the total number of spatial filters used by the base station and information about the number of spatial filters used by the base station in each synchronization signal block.

According to an example of the present disclosure, wherein the spatial filters of the base station indicate transmission beams of the base station, the method further includes beam scanning the transmission beams of the base station in a beam scanning period to obtain reference signal reception power of the transmission beams, wherein one beam scanning period includes a plurality of synchronization signal block burst set periods.

According to an example of the present disclosure, the method further includes determining a preferred transmission beam according to the transmission beam corresponding to the reference signal reception power higher than a first predetermined threshold and the transmission beam corresponding to the reference signal reception power lower than a second predetermined threshold.

According to an example of the present disclosure, the method further includes ending the beam scanning after determining the preferred transmission beam, regardless of remaining time of a current beam scanning period.

According to another aspect of the present disclosure, there is provided a method performed by a base station in a communication system, including: mapping, in one beam scanning period, at least a part of transmission beams of the base station with at least a part of synchronization signal blocks in the beam scanning period in a hash pattern, wherein the one beam scanning period includes a plurality of synchronization signal block burst sets and one synchronization signal block burst set includes a plurality of synchronization signal blocks; and transmitting a specific synchronization signal block using at least one beam corresponding to the specific synchronization signal block, according to a result of the mapping.

According to an example of the present disclosure, the method further includes transmitting information about spatial filters of the base station, wherein the spatial filters of the base station indicate transmission beams of the base station.

According to an example of the present disclosure, the method further includes determining at least one spatial filter index corresponding to a specific synchronization signal block index by using a pseudo-random sequence generator according to information about an index of a synchronization signal block burst set associated with spatial filters of the base station and information about indexes of synchronization signal blocks in the synchronization signal block burst set.

According to another aspect of the present disclosure, there is provided a terminal device including: a receiving unit configured to receive information about spatial filters of a base station; a control unit configured to determine at least one spatial filter index corresponding to a specific synchronization signal block index according to information about the spatial filters of the base station, wherein the at least one spatial filter index corresponding to the specific synchronization signal block index is generated by using a pseudo-random sequence generator.

According to an example of the present disclosure, wherein the information about the spatial filters of the base station includes information about an index of a synchronization signal block burst set associated with the spatial filters of the base station and information about indexes of synchronization signal blocks in the synchronization signal block burst set, wherein one synchronization signal block burst set includes a plurality of synchronization signal blocks.

According to an example of the present disclosure, wherein the receiving unit receives information about a system frame number; the control unit determines the information about the index of the synchronization signal block burst set according to at least a part of bits in the information about the system frame number.

According to an example of the present disclosure, wherein the information about the spatial filters of the base station further includes at least one of information about the total number of spatial filters used by the base station and information about the number of spatial filters used by the base station in each synchronization signal block.

According to an example of the present disclosure, the spatial filters of the base station indicate transmission beams of the base station; the control unit is further configured to beam scan the transmission beams of the base station in a beam scanning period to obtain reference signal reception power of the transmission beams, wherein one beam scanning period includes a plurality of synchronization signal block burst set periods.

According to an example of the present disclosure, the control unit is further configured to determine a preferred transmission beam according to the transmission beam corresponding to the reference signal reception power higher than a first predetermined threshold and the transmission beam corresponding to the reference signal reception power lower than a second predetermined threshold.

According to an example of the present disclosure, the control unit is further configured to end the beam scanning after determining the preferred transmission beam, regardless of remaining time of a current beam scanning period.

According to another aspect of the present disclosure, there is provided a base station, including: a control unit configured to map, in one beam scanning period, at least a part of transmission beams of the base station with at least a part of synchronization signal blocks in the beam scanning period in a hash pattern, wherein the one beam scanning period includes a plurality of synchronization signal block burst sets and one synchronization signal block burst set includes a plurality of synchronization signal blocks; a transmitting unit configured to transmit a specific synchronization signal block using at least one beam corresponding to the specific synchronization signal block, according to a result of the mapping.

According to an example of the present disclosure, wherein the transmitting unit is further configured to transmit information about spatial filters of the base station, wherein the spatial filters of the base station indicate transmission beams of the base station.

According to an example of the present disclosure, wherein the control unit is further configured to determine at least one spatial filter index corresponding to a specific synchronization signal block index by using a pseudo-random sequence generator according to information about an index of a synchronization signal block burst set associated with spatial filters of the base station and information about indexes of synchronization signal blocks in the synchronization signal block burst set.

According to the method performed by the terminal, the method performed by the base station, and the corresponding terminal and base station, the efficiency of the beam search operation is improved, the RS overhead is reduced, and the time for the terminal to access the base station is shortened, thereby improving the performance of the communication system.

### BRIEF DESCRIPTION OF DRAWINGS

The above and other objects, features and advantages of the present disclosure will become more obvious by describing embodiments of the present disclosure in more detail in conjunction with accompanying drawings. The accompanying drawings are provided to provide a further understanding of the embodiments of the present disclosure, constitute a part of the specification, serve to explain the present disclosure together with the embodiments of the present disclosure, and do not constitute a limitation of the present disclosure. In the drawings, like reference numerals usually represent like components or steps.

FIG. 1 shows a schematic diagram of a wireless communication system in which embodiments of the present disclosure may be applied.

FIG. 2 shows a flowchart of a method performed by a terminal according to an embodiment of the present disclosure.

FIG. 3A schematically shows an operation of performing hash mapping on a plurality of beams.

FIG. 3B schematically shows another operation of performing the hash mapping on the plurality of beams.

FIG. 3C schematically shows an example of performing a hash mapping operation on transmission beams according to an embodiment of the present disclosure.

FIG. 3D schematically illustrates another example of performing a hash mapping operation on transmission beams according to an embodiment of the present disclosure.

FIG. 4 shows a schematic diagram showing a wireless communication system 100 to which an embodiment of the present disclosure is applied.

FIG. 5 shows a flowchart of a method performed by a base station according to an embodiment of the present disclosure.

FIG. 6 shows a structural schematic diagram of the base station according to an embodiment of the present disclosure.

FIG. 7 shows a structural schematic diagram of the terminal according to an embodiment of the present disclosure.

FIG. 8 is a schematic diagram of a hardware structure of a communication device according to an embodiment of the present disclosure.

### DETAILED DESCRIPTION

In order to make the objects, technical solutions and advantages of the present disclosure more obvious, exemplary embodiments according to the present disclosure will be described in detail below with reference to the accompanying drawings. Like reference numerals refer to like elements throughout the drawings. It should be appreciated that the embodiments described herein are merely illustrative and should not be construed as limiting the scope of the present disclosure.

First, a wireless communication system in which an embodiment of the present disclosure may be applied will be described with reference to FIG. 1. FIG. 1 shows a schematic diagram of the wireless communication system in which an embodiment of the present disclosure may be applied. The wireless communication system 100 shown in FIG. 1 may be a 5G communication system or any other type of wireless communication system, such as a 6G communication system, etc. Hereinafter, embodiments of the present disclosure are described by taking the 5G communication system as an example, but it should be recognized that the following description can also be applied to other types of wireless communication systems.

As shown in FIG. 1, the wireless communication system 100 may include a base station 110 and a terminal 120, and the base station 110 is a serving base station of the terminal 120. The terminal 120 may communicate with the base station 110 via a downlink. The downlink refers to a communication link from the base station 110 to the terminal 120. In the downlink, the base station 110 may sequentially transmit Reference Signals (RSs) using beams with different directions, which is called beam scanning. The terminal 120 may measure the reference signals transmitted by the beams with different directions, and determine the best transmission beam aligning the terminal 120 according to measurement results.

The base station 110 can sequentially transmit synchronization signals and physical broadcast channel blocks (SSB) to the terminal 120 on 64 transmission beams with different directions in a Time Division Multiplexing, TDM) manner. Each SSB corresponds to a specific transmission beam. The terminal 120 may measure a mixed Reference Signal Received Power (RSRP) of each SSB received from each transmission beam. The terminal 120 selects an optimal SSB and a beam used by the terminal 120 to receive the SSB for subsequent communication, according to the received RSRP measurement result of each SSB. As shown in FIG. 1, for an SBB Burst (i.e., a half frame of 5 ms) in a SSB burst period, the base station 110 sequentially transmits SSBs with SSB indexes of SSB #0, SSB #1, SSB #2, . . . , SSB #63 on the transmission beams with beam indexes of transmission beam #0, transmission beam #2, . . . , transmission beam #63, respectively. The terminal 120 receives each SSB on a reception beam whose beam index is reception beam #0 and measures the RSRP of each SSB. The terminal 120 receives each SSB on the reception beam whose beam index is reception beam #1 and measures the RSRP of each SSB. The terminal 120 selects a best transmission-reception beam pair (for example, a transmission-reception beam pair corresponding to a maximum value of all RSRP measurement results is selected as the best transmission-reception beam pair (for example, transmission beam #0-reception beam #0)) or a best transmission beam (for example, the transmission beam corresponding to the maximum value of all RSRP measurement results is selected as the best transmission beam), according to all received RSRP measurement results of SSB.

The base station described here can provide a communication coverage for a specific geographical area, which can be called a cell, a Node B, a gNB, a 5G Node B, an access point and/or a transmitting and receiving point, etc. The terminal described here may include various types of terminals, such as a User Equipment (UE), a mobile terminal (or called a mobile station) or a fixed terminal, however, for convenience, the terminals and the UE are sometimes used interchangeably hereinafter.

It should be recognized that although only one base station and one terminal are shown in FIG. 1, the wireless communication system may include more base stations and/or more terminals, and one base station may serve multiple terminals, and one terminal may also be served by multiple base stations.

In the process of determining the best transmission-reception beam pair/best transmission beam by the base station described above, the prior art adopts a method of exhausting all transmission-reception beam pairs/best transmission beams, in which each transmission beam needs to be configured with a reference signal corresponding to it one by one. As the number of beams increases (for example, reaching tens of thousands of orders), the overhead of reference signals will increase linearly, and the time for UE to search for the best transmission-reception beam pair/the best transmission beam will increase linearly with the product of the number of transmission beams and the number of reception beams, which will lead to a longer delay time when UE accesses the base station.

In order to overcome the defect in the prior art, the present disclosure hopes to propose a scheme to improve the efficiency of a beam search operation, so as to reduce the RS overhead and shorten the time for the terminal to access the base station, thereby improving the performance of the communication system.

The following will describe the specific implementation of the technical scheme for reducing RS overhead and shortening the time for the terminal to access the base station from the perspective of the terminal and the base station respectively.

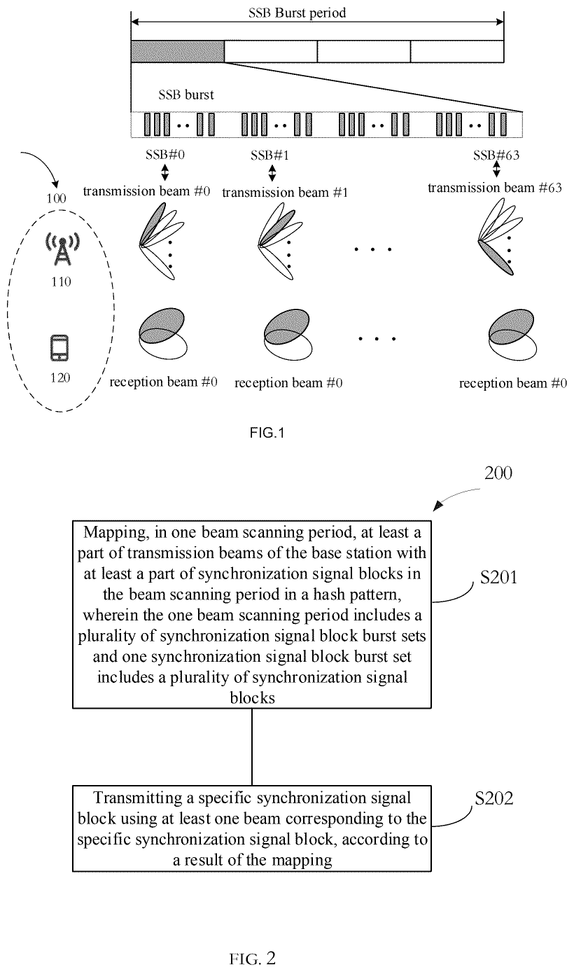

First, a method performed by the base station according to an embodiment of the present disclosure will be described with reference to FIG. 2. FIG. 2 shows a flowchart of a method 200 performed by the base station according to an embodiment of the present disclosure. As shown in FIG. 2, in step S201, at least a part of transmission beams of the base station is mapped, in one beam scanning period, with at least part of synchronization signal blocks in the beam scanning period in a hash pattern, wherein the one beam scanning period includes a plurality of synchronization signal block burst sets and one synchronization signal block burst set includes a plurality of synchronization signal blocks. Then, in step S202, according to a result of the mapping, a specific synchronization signal block is transmitted using at least one beam corresponding to the specific synchronization signal block.

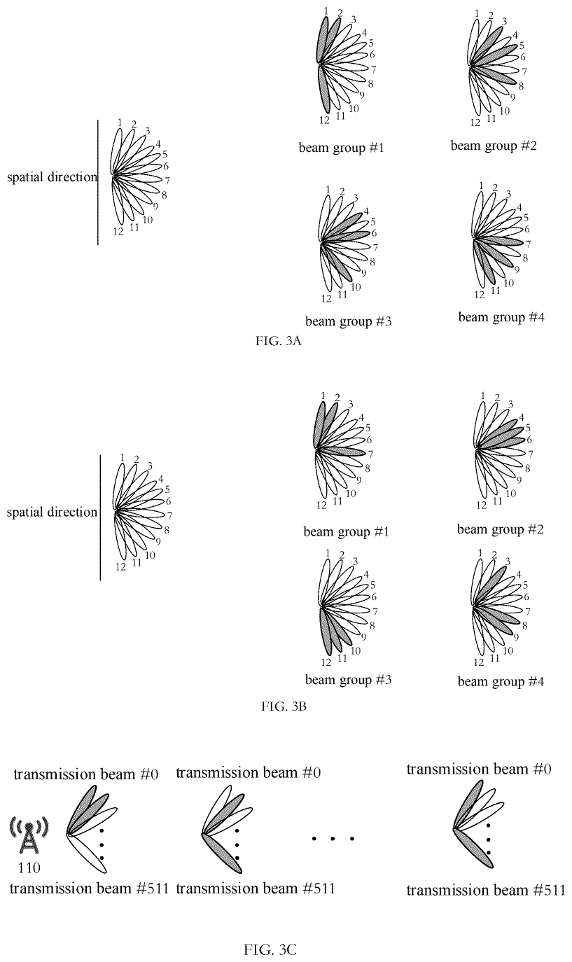

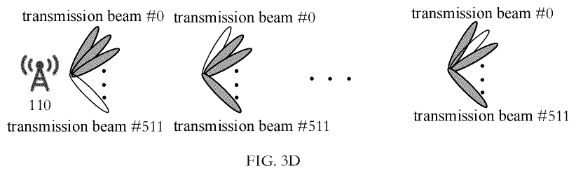

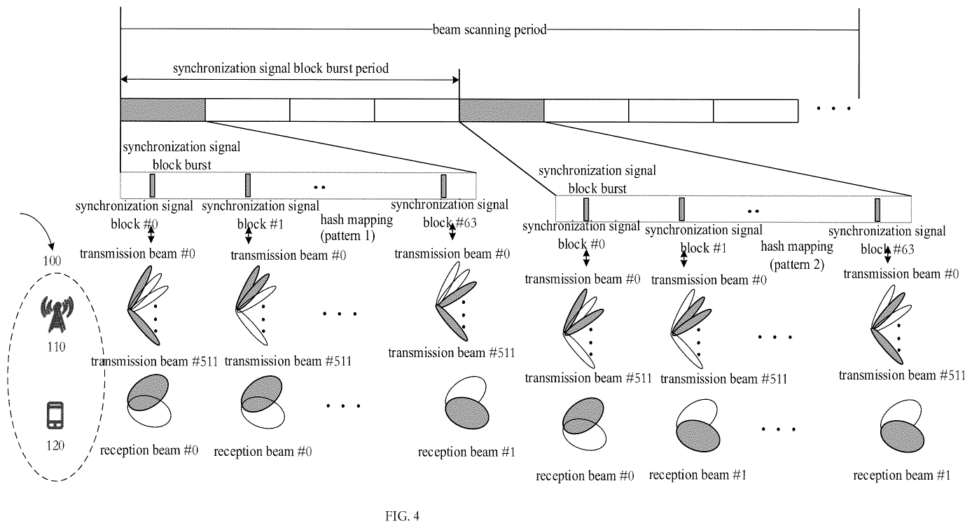

The present disclosure proposes an operation by mapping a beam (especially a transmission beam) into a plurality of beam groups having the hash pattern. The hash pattern here can be obtained by mapping through a hash function or a pseudo-random function mapping relationship (such as a Gold sequence or an m sequence) with characteristics similar to the hash function. In order to facilitate the understanding of a hash mapping operation in the present disclosure, FIGS. 3A and 3B schematically illustrate an operation of performing hash mapping on a plurality of beams. As shown in FIG. 3A, it is assumed there are 12 beams with beam indexes of 1, 2, 3, 4, 5, 6, 7, 8, 9, 10, 11 and 12 in a spatial direction, and each beam has a different spatial direction, for example, beam 1 may be a beam with a spatial direction as shown in FIG. 3A, beam 3 may be a beam with a spatial direction as shown in FIG. 3A, and so on. FIG. 3A shows an operation after a first round of the hash mapping is performed on these 12 beams, which are hash mapped into 4 beam groups, namely, beam group #1, beam group #2, beam group #3 and beam group #4, and each beam group includes 3 beams randomly selected from these 12 beams. For example, beam group #1 includes beam 1, beam 2 and beam 12 randomly selected from these 12 beams, and beam group #2 includes beam 3, beam 5 and beam 8 randomly selected from these 12 beams, etc. FIG. 3B shows an operation after a second round of hash mapping is performed on these 12 beams, which are again hash mapped into 4 beam groups, namely, beam group #1, beam group #2, beam group #3 and beam group #4, and each beam group includes 3 beams randomly selected from these 12 beams. For example, beam group #1 includes beam 1, beam 2 and beam 7 randomly selected from these 12 beams, and beam group #2 includes beam 4, beam 5 and beam 6 randomly selected from these 12 beams, etc.

FIGS. 3C and 3D schematically illustrate an example of performing a hash mapping operation on transmission beams according to an embodiment of the present disclosure. As shown in FIG. 3C, the base station 110 may transmit RSs on 512 transmission beams with different spatial directions, and the beam indexes of these 512 transmission beams are transmission beam #0, transmission beam #1, . . . , and transmission beam #511, respectively. A result after performing a round of the hash mapping operation on these 512 transmission beams is shown in FIG. 3C. The first group of beams includes transmission beam #0 and transmission beam #1 randomly selected from 512 transmission beams, and the second group of beams includes transmission beam #1 and transmission beam #511 randomly selected from 512 transmission beams, etc. FIG. 3D shows a result after performing another hash mapping operation on the 512 transmission beams. The first group of beams includes transmission beam #0, transmission beam #1 and transmission beam #2 randomly selected from the 512 transmission beams, and the second group of beams includes transmission beam #1, transmission beam #2, transmission beam #511 randomly selected from the 512 transmission beams, etc. It should be noted that although FIGS. 3C and 3D show examples in which each beam group includes two beams and three beams respectively, the present disclosure is not intended to be limited to this in any way, and the beam group with the hash pattern according to the embodiment of the present disclosure may include at least one beam, and the number of beams included in each beam group is a configurable parameter of the wireless communication system.

According to an example of the present disclosure, the synchronization signal block in step S201 may include SSB. In the 5G New Radio (NR), SSB includes a synchronization signal and a broadcast signal, and the synchronization signal includes a Primary Synchronization Signal (PSS) and a Secondary Synchronization Signal (SSS). The broadcast signal includes Physical Broadcast Channel (PBCH) data and a Demodulation Reference Signal (DMRS) of PBCH. In this example, the synchronization signal block burst set includes a SSB Burst Set. The SSB burst set refers to a set of a plurality of SSBs within a certain period (for example, 5 ms, 10 ms, 20 ms, 40 ms, etc.), and the plurality of SSBs in the SSB burst set may be used for the beam scanning.

According to an example of the present disclosure, the beam scanning period in step S201 may include one or more synchronization signal block burst sets. For example, if the period of a synchronization signal block burst set is T and a beam scanning period includes N synchronization signal block burst sets (N is an integer greater than or equal to 1), then the beam scanning period is N×T. In this example, N may be a configurable parameter of the wireless communication system, such as N=512 or 1024.

The hash mapping may transform an input with any length into an output with a fixed length through a hash function or a pseudo-random function mapping relationship (such as a Gold sequence or an m sequence) with characteristics similar to the hash function. For example, the hash mapping may be performed by a manner of the pseudo-random number generation. For example, the hash mapping may be realized by a Pseudorandom Noise (PN) generator in 3GPP/TS38.211. FIG. 4 shows a schematic diagram of a wireless communication system 100 to which an embodiment of the present disclosure is applied. Next, step S201 will be exemplarily described with reference to FIG. 4. As shown in FIG. 4, a beam scanning period may include a plurality of synchronization signal block burst periods, each synchronization signal block burst period including a plurality of synchronization signal blocks (i.e., synchronization signal block #0, synchronization signal block #1, . . . , synchronization signal block #63 in FIG. 4) used for beam scanning, and the base station 110 transmits the above synchronization signal blocks for beam scanning to the terminal 120 by using the transmission beams in a TDM manner, in a Frequency Division Multiplexing (FDM) manner, in a Code Division Multiplexing (CDM) manner, and various combinations of the above manners. In the first synchronization signal block burst period, synchronization signal block #0, synchronization signal block #1, . . . , and synchronization signal block #63 may be performed a first round of hash mapping with indexes of transmission beams of the base station 110 (as shown in pattern 1 in FIG. 4), and in the second synchronization signal block burst period, synchronization signal block #0, synchronization signal block #1, . . . , synchronization signal block #63 may be performed a second round of hash mapping with indexes of transmission beams of the base station 110 (as shown in pattern 2 in FIG. 4), and so on, so as to complete the establishment of n rounds of hash mapping between synchronization signal block #0, synchronization signal block #1, . . . , synchronization signal block #63 and indexes of transmission beams of the base station 110 in the whole beam scanning period. In this example, the hash patterns of the transmission beams after each round of hash mapping may be different. For example, the pattern 1 and the pattern 2 in FIG. 4 are different. Specifically, the transmission beams corresponding to synchronization signal block #0 in the pattern 1 are not all the same as those corresponding to synchronization signal block #0 in the pattern 2. The process of hash mapping between the transmission beam and the synchronization signal in the hash pattern has been described in combination with FIG. 3C and FIG. 3D, and will not be repeated here.

It should be recognized that in step S201, a part of all transmission beams of the base station can be mapped with the synchronization signal block in the hash pattern. As shown in FIG. 4, the base station 110 has 512 transmission beams, and when the hash mapping is performed in the pattern 1, a part of the transmission beams of the 512 transmission beams are hash mapped into 64 beam groups, and each beam group includes two transmission beams. Alternatively, in step S201, all the transmission beams of the base station can be mapped with the synchronization signal in the hash pattern in each round of hash mapping (similar to the situation shown in FIGS. 3A and 3B), that is, the transmission times of each transmission beam of the base station used to transmit the synchronization signal block are equal in the whole beam scanning period. In this alternative embodiment, by equalizing the transmission opportunities (also called transmission opportunities) of each transmission beam of the base station, the uniform coverage of a cell is realized, and the overall performance of the communication system is improved. As another example, the transmission opportunity of each beam may also be adjusted according to the distribution of users in an area to realize unequal transmission opportunities. That is, the beam transmission opportunity corresponding to a user-intensive area is higher, while the beam transmission opportunity corresponding to a user-sparse area is lower.

Next, step S202 will be described with reference to FIG. 4. After the hash mapping between a synchronization signal block index and transmission beam indexes is established, the base station 110 may transmit the synchronization signal block corresponding to the synchronization signal block index to the terminal 120 on the transmission beams corresponding to each synchronization signal block index. For example, after the first round of hash mapping, transmission beam #0 and transmission beam #511 may be used to transmit synchronization signal block #0, transmission beam #0 and transmission beam #1 may be used to transmit synchronization signal block #1, etc. After the second round of hash mapping, synchronization signal block #0 may be transmitted using transmission beam #0 and transmission beam #2, synchronization signal block #1 may be transmitted using transmission beam #1 and transmission beam #2, and so on. It should be recognized that after the synchronization signal block is transmitted to the terminal 120, the terminal 120 may demodulate the synchronization signal block and measure the synchronization signal block, such as measuring received signal strength and received signal quality of the synchronization signal block. The terminal 120 may determine an optimal transmission-reception beam pair (for example, a pair of transmission beam #0-reception beam #0 in FIG. 4) or an optimal transmission beam (for example, transmission beam #0 in FIG. 4) according to results of the measuring.

In the above example of the present disclosure, the transmitting beam is hashed into a plurality of beam groups in a pseudo-random manner, each beam group includes at least one beam, and a beam searching operation is performed based on the beam group with the hash pattern to determine the optimal transmission-reception beam pair/optimal transmission beam, thereby reducing the RS overhead, shortening the time for the terminal to access the base station, and improving the performance of the communication system.

According to another example of the present disclosure, the step S202 further includes transmitting information about spatial filters of the base station, wherein the spatial filters of the base station indicate transmission beams of the base station.

In a precoding/beam forming (also known as a smart antenna) technology, a set of fixed weighting factors correspond to a precoding matrix, and a beam direction may be realized by applying a weighting factor to each antenna, and the value of the weighting factor is each component in the precoding matrix. By changing the weighting factor, the beam may be pointed in another direction, that is, spatial filtering may be realized. For the sake of clarity, the spatial filter and the beam are equivalent herein and may be used interchangeably. In this example, the spatial filter of the base station may be a precoding matrix indicating the direction of the transmission beam of the base station in a spatial domain in the beam forming technology, and the spatial filter of the base station indicates the transmission beam of the base station.

According to an example of the present disclosure, information about the spatial filters of the base station may include indexes of one or more transmission beams corresponding to a specific SSB after hash mapping, so that a terminal device may directly obtain at least one spatial filter index corresponding to a specific synchronization signal block according to the information about the spatial filters of the base station. Alternatively, the information about the spatial filters of the base station may include information about indexes of synchronization signal block burst sets associated with the spatial filters of the base station and information about indexes of synchronization signal blocks in the synchronization signal block burst sets, so that the terminal device may determine the at least one spatial filter index corresponding to the specific synchronization signal block index by using, for example, a pseudo-random sequence generator. These two embodiments will be described respectively below.

In one example, the base station 110 may transmit the index of the transmission beams used to transmit a specific synchronization signal block after the hash mapping of the synchronization signal block index and the transmission beam indexes is established. For example, the base station 110 may transmit the indexes of the transmission beams used to transmit synchronization signal block #0 after the first round of hash mapping shown in FIG. 4: transmission beam #0 and transmission beam #511. In this example, the information about the spatial filters of the base station includes spatial filter indexes, which are indexes generated by the pseudo-random sequence generator and associated with the specific synchronization signal block. In this example, the base station 110 may explicitly inform the terminal 120 of the transmission beam indexes after the hash mapping, and the terminal 120 does not need to perform the hash mapping operation on the transmission beams, which is convenient for the terminal 120 to quickly perform the beam scanning operation, reduces the power consumption of the UE, which improves the overall performance of the communication system.

In another example, the base station 110 may transmit the information about indexes of synchronization signal block burst sets associated with the spatial filters of the base station 110, information about indexes of synchronization signal blocks in the synchronization signal block burst sets. In this example, the base station 110 performs the hash mapping operation according to the indexes of the synchronization signal block burst sets and the indexes of the synchronization signal blocks in the synchronization signal block burst sets, to generate one or more spatial filter indexes used by the base station to transmit the synchronization signal block; The terminal 120 performs the hash mapping operation described above in this disclosure according to the received information, to obtain information of the spatial filter indexes used by the base station 110 to transmit the synchronization signal block. In this example, since the base station 110 only needs to transmit the information about the indexes of the synchronization signal block burst sets associated with the spatial filters of the base station 110 and the information about the indexes of the synchronization signal blocks in the synchronization signal block burst sets to the terminal 120, it is not necessary to transmit the indexes of the transmission beams used to transmit each synchronization signal block after each round of hash mapping, thus reducing the signaling overhead between the base station 110 and the terminal 120 and improving the overall performance of the communication system. As another example, all synchronization signal blocks in a synchronization signal scanning period may be indexed continuously without explicitly defining each synchronization signal block burst period in a synchronization signal scanning period. In this way, the synchronization signal block index is the index of all synchronization signal blocks in a synchronization signal scanning period. In this example, the base station 110 performs the hash mapping operation according to the synchronization signal block index to generate one or more spatial filter indexes used by the base station to transmit the synchronization signal block; the terminal 120 performs the hash mapping operation described above in this disclosure according to the received synchronization signal block index, to obtain information of the spatial filter indexes used by the base station 110 to transmit the synchronization signal block.

In this example, the information about the synchronization signal block index includes information about an index of a synchronization signal block burst set and information about indexes of synchronization signal blocks in the synchronization signal block burst set, wherein one synchronization signal block burst set includes a plurality of synchronization signal blocks. In this example, the index of the synchronization signal block burst set may include the index of each synchronization signal block burst set in a whole beam scanning period. For example, in FIG. 4, the whole beam scanning period includes N synchronization signal block burst periods, and the hash mapping of the pattern 1 is performed on the first synchronization signal block burst period set, and the hash mapping of the pattern 2 is performed on the second synchronization signal block burst period set. The indexes of synchronization signal block burst sets corresponding to the N synchronization signal block burst periods sorted in time domain may be synchronization signal block burst set #0, synchronization signal block burst set #1 . . . synchronization signal block burst set #N−1 in turn. In this example, the indexes of synchronization signal blocks in the synchronization signal block burst set may include the indexes of respective synchronization signal blocks in a current synchronization signal block burst set, for example, in the synchronization signal block burst set corresponding to the first synchronization signal block burst period in FIG. 4, the indexes of respective synchronization signal blocks are synchronization signal block #0, synchronization signal block #1, . . . , synchronization signal block #63 and so on, and in the second synchronization signal block burst set, the indexes of respective synchronization signal blocks are synchronization signal block #0, synchronization signal block #1, . . . , synchronization signal block #63 and so on. As another example, all synchronization signal blocks in a synchronization signal scanning period may be indexed continuously without explicitly defining each synchronization signal block burst period in a synchronization signal scanning period. For example, in FIG. 4, the indexes of N times 64 synchronization signal blocks in the whole beam scanning period are synchronization signal block #0, synchronization signal block #1 . . . and synchronization signal block #(64N−1). In this example, the information about the spatial filter indexes of the base station may be indicated by explicitly defined signaling, which may be the signaling of encoding the information about the spatial filter indexes of the base station with a certain number of bits, for example, the signaling may be encoding 4096 transmission beam indexes on the base station 110 side with 12 bits. According to another example of the present disclosure, the maximum number of bits (for example, 12 bits) used for signaling indicating the information about the spatial filter indexes of the base station may be defined by a wireless communication system standard. In this example, the number of actually used bits indicating the information of the spatial filter indexes used for transmitting the synchronization signal block may be smaller than the maximum value (for example, 12 bits) of the length of the signaling, that is, the number of spatial filters is smaller than that indicated by the maximum value of the length of the signaling. In this example, the number of the actually used bits of the information of the spatial filter indexes for transmitting the synchronization signal block may be indicated, for example, the indication may be transmitted in a PBCH, and higher bits in the signaling that exceed the number of the actually used bits are meaningless. As another example, some spatial filters may be reused to obtain spatial filters with the same number as the maximum number of bits used for the signaling indicating information about the spatial filter indexes of the base station, instead of indicating the length of the number of the actually used bits. At this time, the same spatial filter may correspond to index information of a plurality of spatial filters. For example, when the maximum number of bits is 12 and 11 bits are actually used, spatial filter index 0 and spatial filter index 2048 use the same spatial filter . . . spatial filter index 2047 and spatial filter index 4095 use the same spatial filter; As another example, the index information of spatial filters exceeding the actual number of spatial filters may also be corresponding to no transmission signal. For example, when the maximum number of bits is 12 bits and 11 bits are actually used, spatial filter indexes 2048 to 4095 all correspond to zero beam.

According to another example of the present disclosure, the method 200 further includes determining at least one spatial filter index corresponding to a specific synchronization signal block index by using a pseudo-random sequence generator according to the information about the spatial filters of the base station. In this example, the information about the synchronization signal block indexes may be determined by the index (labeled L₁) of the synchronization signal block burst set and the indexes (labeled L₂) of synchronization signal blocks in the synchronization signal block burst set described above. The index of each synchronization signal block in the whole beam scanning period can be determined by L₁ and L₂. Alternatively, the pseudo-random sequence generator here may be a pseudo-random sequence (PN) generator in 3GPP/TS38.211. The step of determining at least one spatial filter index corresponding to a specific synchronization signal block index by using a PN generator are as follows: initializing the PN generator to obtain an initial sequence cᵢₙᵢₜ, and as an example, cᵢₙᵢₜ is obtained by multiplying a cell ID by a standard given constant, that is, the random sequence generator is initialized by using the cell ID, or cᵢₙᵢₜ may also be initialized by using other standard agreed constants or variables; multiplexing the PN generator to generate a pseudo-random sequence c(n) according to the initial sequence cᵢₙᵢₜ; and transforming the pseudo-random sequence c(n) into spatial filter indexes according to the following equation (1):

$${I}_{m} = {Σ}_{i = 0}^{K - 1} {2}^{i} c ( ( ( {L}_{1} {L}_{max} + {L}_{2} ) M + n ) K + i ) \qquad ( 1 )$$

where Iₘ is the spatial filter indexes corresponding to the specific synchronization signal block index, K is the length of the spatial filter index, L₁ is the index of the synchronization signal block burst set, L₂ is the indexes of the synchronization signal blocks in the synchronization signal block burst set, Lₘₐₓ is the maximum value of L2, M is the number of spatial filters used to transmit the synchronization signal block, m=0, . . . , M−1. In another example, when there is no need to explicitly define the synchronization signal block burst set, L₁ and L₂ may not be explicitly distinguished, and are implied as a part of the indexes L of the synchronization signal blocks. As an example, the value of L satisfies the relationship of L=L₁ Lₘₐₓ+L₂. Equation (1) may be written in the following form:

$${I}_{m} = {Σ}_{i = 0}^{K - 1} {2}^{i} c ( ( LM + m ) K + i ) \qquad ( 2 )$$

According to another example of the present disclosure, the information about the spatial filters of the base station may further include at least one of information about the total number of spatial filters used by the base station and information about the number of spatial filters used by the base station in each synchronization signal block. The total number of spatial filters used by the base station may be the total number of all transmission beams with different spatial directions on the base station side. For example, in FIG. 4, the total number of transmission beams used by the base station 110 is 512. The information about the number of spatial filters used by the base station in each synchronization signal block may be the number of beams included in a beam group corresponding to each synchronization signal block in each round of hash mapping. For example, in FIG. 4, the number of transmission beams corresponding to each synchronization signal block is 2. In this example, signaling can be used to indicate information about the number of spatial filters used by the base station in each synchronization signal block. For example, if the information of the number of spatial filters used by the base station in each synchronization signal block is 1, 2, 4 and 8 in one beam scanning period, and then it may be encoded by signaling with a length of 2 bits. According to another example of the present disclosure, signaling indicating the information about the number of spatial filters used by the base station in each synchronization signal block may be transmitted in a PBCH.

According to another example of the present disclosure, the step S202 further includes transmitting a message about a system frame number, wherein at least a part of bits in the message about the system frame number are used to indicate the information about the index of the synchronization signal block burst set. In this example, the system frame number may be the System Frame Number (SFN) contained in a Master Information Block (MIB) in the System Information of the cell, and the length of the SFN is 10 bits, which may be transmitted in the PBCH. In this example, the mapping of the SFN to the index of the synchronization signal block burst set may be determined according to the period of the synchronization signal block burst set (for example, 20 ms). For example, the index of the synchronization signal block burst set may be encoded by taking the upper 9 bits in the SFN. According to another example of the present disclosure, signaling for indicating the index of the synchronization signal block burst set may also be added in the synchronization signal block, and the signaling may be transmitted in the PBCH.

Through the method performed by the base station in the embodiment of the present disclosure, the method improves the efficiency of the beam searching operation, reduces the RS overhead, and shortens the time for the terminal to access the base station, thereby improving the performance of the communication system.

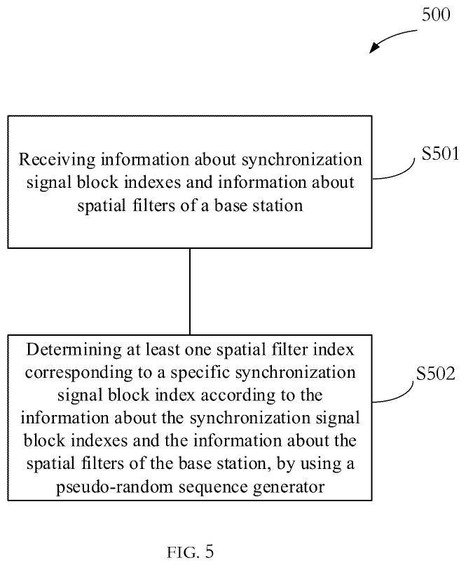

Next, a method performed by a terminal according to an embodiment of the present disclosure will be described with reference to FIG. 5. FIG. 5 shows a flowchart of a method performed by a terminal according to an embodiment of the present disclosure. Since some details of the method 500 are the same as those of the method 200 described above with reference to FIG. 2, a detailed description of the same content is omitted for the sake of simplicity.

As shown in FIG. 5, in step S501, information about spatial filters of a base station is received. In step S502, at least one spatial filter index corresponding to a specific synchronization signal block index is determined according to the information about the spatial filters of the base station, wherein the at least one spatial filter index corresponding to the specific synchronization signal block index is generated by using a pseudo-random sequence generator.

In this example, the terminal 120 may receive indexes of the transmission beams after hash mapping, and may also receive an index of a synchronization signal block burst set used to perform the hash mapping and indexes of synchronization signal blocks in the synchronization signal block burst set. These two embodiments will be described respectively below.

In one example, the terminal 120 may receive indexes of the transmission beams for transmitting a specific synchronization signal block after the hash mapping between the synchronization signal block index and the transmission beam indexes is established, which is transmitted by the base station 110. For example, the terminal 120 may receive the indexes of the transmission beams shown in FIG. 4 transmitted by the base station 110, which are used to transmit the synchronization signal block #0 after the first round of the hash mapping: transmission beam #0 and transmission beam #511. In this example, the information about the spatial filters of the base station includes spatial filter indexes, which are indexes generated by a pseudo-random sequence generator and associated with a specific synchronization signal block. The terminal 120 can demodulate the received information about the spatial filters of the base station to obtain the spatial filter indexes corresponding to the specific synchronization signal block index. In this example, the terminal 120 does not need to perform a hash mapping operation on the transmission beams, which is convenient for the terminal 120 to quickly perform the beam scanning operation, reduces the power consumption of the UE, and improves the overall performance of the communication system.

According to another example of the present disclosure, the information about the spatial filters of the base station includes information about an index of a synchronization signal block burst set associated with the spatial filters of the base station and information about indexes of synchronization signal blocks in the synchronization signal block burst set. In this example, the information about the indexes of the synchronization signal blocks may be determined by the index (labeled L₁) of the synchronization signal block burst set and the indexes (labeled L₂) of the synchronization signal blocks in the synchronization signal block burst set described above. The index of each synchronization signal block in the whole beam scanning period may be determined by L₁ and L₂. The terminal 120 performs the hash mapping operation described above in this disclosure according to the received L₁ and L₂, and obtains index information of the spatial filters used by the base station 110 to transmit the synchronization signal block. In this example, since the base station 110 only needs to transmit the information about the index of the synchronization signal block burst set associated with the spatial filters of the base station and the indexes of the synchronization signal blocks in the synchronization signal block burst set to the terminal 120, it is not necessary to transmit the indexes of the transmission beams used to transmit each synchronization signal block after each round of the hash mapping, the signaling overhead between the base station 110 and the terminal 120 is reduced and the overall performance of the communication system is improved. As another example, all synchronization signal blocks in a synchronization signal scanning period may be indexed continuously without explicitly defining each synchronization signal block burst period in a synchronization signal scanning period. In this way, the synchronization signal block index is the index of all synchronization signal blocks in a synchronization signal scanning period. In this example, the base station 110 performs the hash mapping operation according to the indexes of the synchronization signal blocks to generate one or more spatial filter indexes used by the base station to transmit the synchronization signal block; the terminal 120 performs the hash mapping operation described above in this disclosure according to the received indexes of the synchronization signal blocks, to obtain information of the spatial filter indexes used by the base station 110 to transmit the synchronization signal block.

Alternatively, the pseudo-random sequence generator in the above step S502 may be a pseudo-random sequence (PN) generator in 3GPP/TS38.211. The step of determining at least one spatial filter index corresponding to a specific synchronization signal block index by using a PN generator are as follows: initializing the PN generator to obtain an initial sequence cᵢₙᵢₜ; multiplexing the PN generator to generate a pseudo-random sequence c(n) according to the initial sequence cᵢₙᵢₜ; and transforming the pseudo-random sequence c(n) into spatial filter indexes according to the above equation (1). In another example, when the synchronization signal block burst set is not explicitly defined, L₁ and L₂ may not be explicitly distinguished, and are implied as a part of the indexes L of the synchronization signal blocks. As an example, the value of L satisfies the relationship of L=L₁ Lₘₐₓ+L₂. In this case, the pseudo-random sequence c(n) may be transformed into the spatial filter indexes according to the above equation (2).

According to another example of the present disclosure, step S501 further includes receiving information about a system frame number and step S502 further includes determining the information about the index of the synchronization signal block burst set according to at least a part of bits in the information about the system frame number. Therefore, the UE may reuse the information about the system frame number to determine the index of the synchronization signal block burst set, which reduces the signaling overhead.

According to another example of the present disclosure, the information about the spatial filters of the base station further includes at least one of information about the total number of spatial filters used by the base station and information about the number of spatial filters used by the base station in each synchronization signal block. The total number of spatial filters used by the base station may be the total number of all transmission beams with different spatial directions on the base station side. For example, in FIG. 4, the total number of transmission beams used by the base station 110 is 512. The information of the number of spatial filters used by the base station in each synchronization signal block may be the number of beams included in a beam group corresponding to each synchronization signal block in each round of hash mapping. For example, in FIG. 4, the number of transmission beams corresponding to each synchronization signal block is 2. In this example, the information of the number of spatial filters used by the base station in each synchronization signal block may be indicated by using signaling. For example, if information of the number of spatial filters used by the base station in each synchronization signal block is 1, 2, 4 and 8 in one beam scanning period, it may be encoded by signaling with a length of 2 bits. Thus, the UE can determine the beam to be mapped according to at least one of information about the total number of spatial filters used by the base station and information about the number of spatial filters used by the base station in each synchronization signal block. According to another example of the present disclosure, signaling indicating information about the number of spatial filters used by the base station in each synchronization signal block may be transmitted in a PBCH.

According to another example of the present disclosure, the spatial filters of the base station indicate the transmission beams of the base station and step S502 further includes beam scanning at least one synchronization signal block transmitted by the base station in a beam scanning period to obtain reference signal reception power of at least part of the transmission beams, wherein one beam scanning period includes a plurality of synchronization signal block burst sets. It should be recognized that in step S502, a part of all transmission beams of the base station mapped with the synchronization signal block in a hash pattern can be received. As shown in FIG. 4, the base station 110 has 512 transmission beams, and when the hash mapping is performed in pattern 1, a part of the transmission beams of the 512 transmission beams are hash mapped into 64 beam groups, and each beam group includes two transmission beams. Alternatively, in step S502, the whole of all the transmitting beams of the base station may be mapped with the synchronization signal in a hash pattern in each round of hash mapping (similar to the situation shown in FIGS. 3A and 3B), that is, the receiving times of each transmitting beam of the base station used to receive the synchronization signal block are equal in the whole beam scanning period. In this alternative embodiment, the receiving opportunities of respective transmitting beams of the synchronization signal block are equalized, which avoids the occurrence of the worst situation that the synchronization signal of the best transmitting beam cannot be received, and improves the overall performance of the communication system.

According to another example of the present disclosure, step S502 further includes determining a preferred transmission beam according to a transmission beam corresponding to the reference signal reception power higher than a first predetermined threshold and a transmission beam corresponding to the reference signal reception power lower than a second predetermined threshold.

A beam detection algorithm in the prior art will be described with reference to FIG. 1. As shown in FIG. 1, for a SSB burst in a SSB burst period, the terminal 120 receives, on a reception beam with a beam index of reception beam #0, each SSB transmitted on transmission beams with the beam index of transmission beam #0, transmission beam #1, transmission beam #2, . . . transmission beam #63, and measures the RSRP of each SSB. The measurement results of the terminal 120 are shown in Table 1-1:

TABLE 1-1

| | transmission | transmission | transmission | | transmission |
|---|---|---|---|---|---|
| | beam #0 | beam #1 | beam #2 | . . . | beam #63 |
| reception | 1 dB | 0 dB | 0 dB | . . . <15 dB | 15 dB |
| beam #0 | | | | | |

Then, according to the above table, a transmission-reception beam pair with the largest reception power gain (i.e. transmission beam #63-reception beam #0) is selected as an optimal transmission-reception beam pair or the transmission beam (i.e. transmission beam #63) with the largest reception power gain is selected as an optimal transmission beam. Because the existing technology adopts an exhaustive beam detection algorithm, with the increase of the number of transmission beams, the time for UE to select the best beam will become longer, which will lead to the delay of UE's access to the network. Therefore, the present disclosure proposes a beam detection algorithm based on two-way voting, which provides a positive vote for the transmission beam corresponding to the reference signal reception power higher than the first predetermined threshold, and provides a negative vote for the transmission beam corresponding to the reference signal reception power lower than the second predetermined threshold. An example of the beam detection algorithm of the present disclosure will be described with reference to FIG. 4. As described above, in the first round of hash mapping, the terminal 120 may receive synchronization signal block #0 on transmission beam #0 and transmission beam #511, and receive synchronization signal block #1 on transmission beam #0 and transmission beam #1, and so on. After that, the terminal 120 may perform RSRP measurement for each synchronization signal block, and RSRP measurement results are shown in Table 1-2:

TABLE 1-2

| transmission beam #0 + | | |
|---|---|---|
| transmission beam | transmission beam #0 + | |
| #511 | transmission beam #1 | . . . |
| 15 dB | −3 dB | . . . |

Next, the terminal may vote on the measurement result of each synchronization signal block, and the measurement result of each synchronization signal block may provide vote information for selecting the preferred transmission beam. For example, for the RSRP measurement result of synchronization signal block #0 in the first round of hash mapping, vote information of transmission beam #0 and transmission beam #511 may be provided, and for the RSRP measurement result of synchronization signal block #1 in the first round of hash mapping, vote information of transmission beam #0 and transmission beam #1 may be provided. In this example, the transmission beam may correspond to multiple RSRP measurement results, the RSRP with a reception power gain higher than a first threshold (for example, 5 dB) may provide a positive vote of the transmission beam, and the RSRP with a reception power gain lower than a second threshold (for example, 0 dB) or the synchronous signal block being not detected may provide a negative vote of the transmission beam, thereby lowering or rejecting the positive vote of the transmission beam. Table 1-3 below shows an example of this two-way voting algorithm:

TABLE 1-3

| | transmission | transmission | transmission | |
|---|---|---|---|---|
| | beam #0 | beam #1 | beam #511 | . . . |
| first measurement | 15 dB | | 15 dB | . . . |
| result | | | | |
| second measurement | −3 dB | −3 dB | | . . . |
| result | | | | |
| amount to | −3 dB | −3 dB | 15 dB | |

As shown in the above table, transmission beam #0 has two RSRP measurement results, the first measurement result is 15 dB, and the second measurement result is −3 dB. The first measurement result is higher than the first threshold (for example, 5 dB), which may provide a positive vote (keep 15 dB), and the second measurement result is lower than the second threshold (for example, 0 dB), which may provide a rejection vote for the positive vote, so the final voting result of transmission beam #0 is −3 dB.

Table 1-4 below shows another example of this two-way voting algorithm:

TABLE 1-4

| | transmission | transmission | transmission | |
|---|---|---|---|---|
| | beam #0 | beam #1 | beam #511 | . . . |
| first measurement | 15 dB | | 15 dB | . . . |
| result | | | | |
| second measurement | −3 dB | −3 dB | | . . . |
| result | | | | |
| amount to | 12 dB | −3 dB | 15 dB | |

As shown in the above table, transmission beam has two RSRP measurement results, the first measurement result is 15 dB, and the second measurement result is −3 dB. The first measurement result is higher than the first threshold (for example, 5 dB), which may provide a positive vote (keep 15 dB), and the second measurement result is lower than the second threshold (for example, 0 dB), which may lower the positive vote, so the final voting result of transmission beam #0 is 12 dB.

Although this disclosure provides two examples of the two-way voting algorithm, based on the above two examples, the two-way voting algorithm may be derived into more implementations. For example, different measurement results may be weighted. Specifically, a smaller weight may be given to the measurement result that exceeds the first RSRP threshold or a larger value among a plurality of measurement results, and a higher weight may be given to the measurement result that is smaller than the second RSRP threshold or a smaller value among a plurality of measurement results. When the weight of the lower measurement result is 1 and the weight of the higher measurement result is 0, the algorithm may be degenerated to the example in Table 1-3, that is, the measurement result is weighted according to the minimum value.

Table 1-3 and table 1-4 show a situation that UE uses fixed beams for reception. During receiving SSBs of the base station, UE may also randomly switch reception beams, and at this time, each column in the table should contain all combinations of transmission beams and reception beams. For example, in the case that the UE has two reception beams, the combination for transmission beam #0 may be transmission beam #0+ reception beam #0 and transmission beam #0+ reception beam #1. According to another example of the present disclosure, step S502 further includes ending the beam scanning after determining the preferred transmission beam, regardless of remaining time of a current beam scanning period. In this example, the reference signal reception power higher than the first predetermined threshold may be the reference signal reception power of a strong transmission beam, for example, the reference signal reception power higher than the first predetermined threshold may be 14 dB. It should be recognized that the reference signal reception power of the strong transmission beam must be the reference signal reception power that may be used to provide positive voting information, but the reference signal reception power that may provide the positive voting information is not necessarily the reference signal reception power of the strong transmission beam. After ambiguity of the strong transmission beam in the table of the transmission beam voting is eliminated, the preferred transmission beam may be determined without considering the remaining time of the current beam scanning period. For example, in the first round of hash mapping in FIG. 4, the RSRP measurement results as shown in Table 1-2 appear, and the strong transmission beams transmission beam #0 and transmission beam #511 appear in the RSRP measurement results. After the voting results in Table 1-3, transmission beam #0 is ruled out as a strong transmission beam. At this time, transmission beam #511 may be directly output as the preferred beam, regardless of the remaining time of the whole beam scanning period. This embodiment may enable the terminal to quickly complete the beam search, and further enable the terminal to quickly access the network.

Through the method performed by the terminal in the embodiment of the present disclosure, the method improves the efficiency of the beam search operation, reduces the RS overhead and shortens the time for the terminal to access the base station, thereby improving the performance of the communication system.

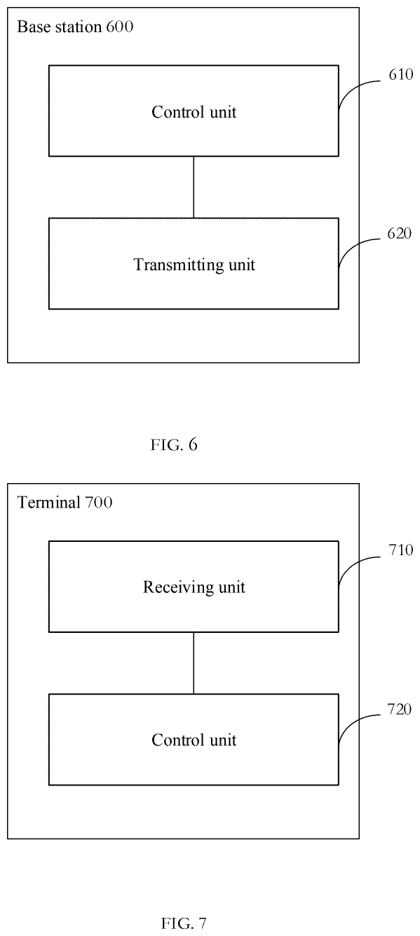

Next, a base station according to an embodiment of the present disclosure will be described with reference to FIG. 6. FIG. 6 is a schematic structural diagram of a base station 600 according to an embodiment of the present disclosure. Since the function of the base station 600 is the same as some details of the method 200 described above with reference to FIG. 2, a detailed description of the same content is omitted for the sake of simplicity. As shown in FIG. 6, the base station 600 includes a control unit 610 configured to map, in one beam scanning period, at least a part of transmission beams of the base station with at least a part of synchronization signal blocks in the beam scanning period in a hash pattern, wherein the one beam scanning period comprises a plurality of synchronization signal block burst sets and one synchronization signal block burst set includes a plurality of synchronization signal blocks; and a transmitting unit 620 configured to transmit a specific synchronization signal block using at least one beam corresponding to the specific synchronization signal block, according to a result of the mapping. In addition to these two units, the base station 600 may also include other components, however, since these components have nothing to do with the contents of the embodiment of the present disclosure, their illustrations and descriptions are omitted here.

According to an example of the present disclosure, the transmitting unit 620 is further configured to transmit information about spatial filters of the base station, wherein the spatial filters of the base station indicate transmission beams of the base station.

According to another example of the present disclosure, the control unit 610 is further configured to determine at least one spatial filter index corresponding to a specific synchronization signal block index by using a pseudo-random sequence generator according to information about an index of a synchronization signal block burst set associated with spatial filters of the base station and information about indexes of synchronization signal blocks in the synchronization signal block burst set.

Through the above base station of the embodiment of the present disclosure, the efficiency of beam search operation is improved, the RS overhead is reduced, and the time for the terminal to access the base station is shortened, thereby improving the performance of the communication system.

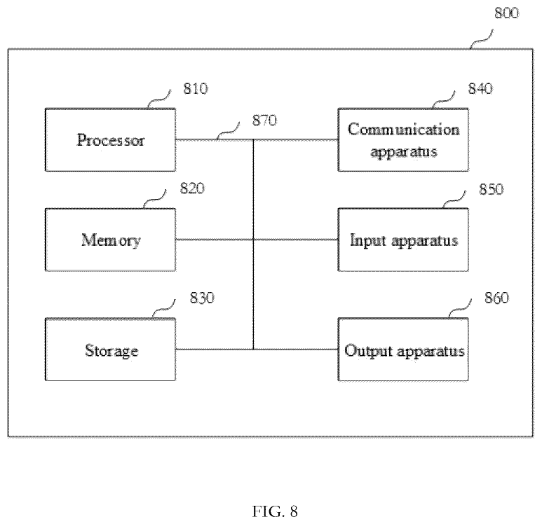

Next, a terminal according to an embodiment of the present disclosure will be described with reference to FIG. 7. FIG. 7 is a schematic structural diagram of a terminal 700 according to an embodiment of the present disclosure. Since the function of the terminal 700 is the same as some details of the method 500 described above with reference to FIG. 5, a detailed description of the same content is omitted for the sake of simplicity. As shown in FIG. 7, the terminal 700 includes a receiving unit 701 configured to receive information about spatial filters of a base station; and a control unit 702 configured to determine at least one spatial filter index corresponding to a specific synchronization signal block index according to information about the spatial filters of the base station, wherein the at least one spatial filter index corresponding to the specific synchronization signal block index is generated by using a pseudo-random sequence generator.

According to an example of the present disclosure, the information about the spatial filters of the base station includes information about an index of a synchronization signal block burst set associated with the spatial filters of the base station and information about indexes of synchronization signal blocks in the synchronization signal block burst set, wherein one synchronization signal block burst set includes a plurality of synchronization signal blocks.

According to an example of the present disclosure, the receiving unit 701 receives information about a system frame number; the control unit 702 determines the information about the index of the synchronization signal block burst set according to at least a part of bits in the information about the system frame number.

According to an example of the present disclosure, the information about the spatial filters of the base station further includes at least one of information about the total number of spatial filters used by the base station and information about the number of spatial filters used by the base station in each synchronization signal block.

According to an example of the present disclosure, the spatial filters of the base station indicate transmission beams of the base station; the control unit 702 is further configured to beam scan the transmission beams of the base station in a beam scanning period to obtain reference signal reception power of the transmission beams, wherein one beam scanning period comprises a plurality of synchronization signal block burst set periods.

According to an example of the present disclosure, the control unit 702 is further configured to determine a preferred transmission beam according to the transmission beam corresponding to the reference signal reception power higher than a first predetermined threshold and the transmission beam corresponding to the reference signal reception power lower than a second predetermined threshold.

According to an example of the present disclosure, the control unit 702 is further configured to end the beam scanning after determining the preferred transmission beam, regardless of remaining time of a current beam scanning period.

Through the above terminal of the embodiment of the present disclosure, the efficiency of the beam search operation is improved, the RS overhead is reduced, and the time for the terminal to access the base station is shortened, thereby improving the performance of the communication system.

### <Hardware Structure>

In addition, block diagrams used in the description of the above embodiments illustrate blocks in units of functions. These functional blocks (structural blocks) may be implemented in arbitrary combination of hardware and/or software. Furthermore, means for implementing respective functional blocks is not particularly limited. That is, the respective functional blocks may be implemented by one apparatus that is physically and/or logically jointed; or more than two apparatuses that are physically and/or logically separated may be directly and/or indirectly connected (e.g. wired and/or wirelessly), and the respective functional blocks may be implemented by these apparatuses.

For example, a communication device (such as the terminal 700, the base station 600) of an embodiment of the present disclosure may function as a computer that executes the processes of the wireless communication method of the present disclosure. FIG. 8 is a schematic diagram of a hardware structure of a communication device 800 (a base station, a terminal) involved in an embodiment of the present disclosure. The above communication device 800 (a base station or terminal) may be constituted as a computer apparatus that physically comprises a processor 810, a memory 820, a storage 830, a communication apparatus 840, an input apparatus 850, an output apparatus 860, a bus 870 and the like

In addition, in the following description, terms such as “apparatus” may be replaced with circuits, devices, units, and the like. The hardware structure of the user terminal and the base station may include one or more of the respective apparatuses shown in the figure, or may not include a part of the apparatuses.

For example, only one processor 810 is illustrated, but there may be multiple processors. Furthermore, processes may be performed by one processor, or processes may be performed by more than one processor simultaneously, sequentially, or with other methods. In addition, the processor 810 may be installed by more than one chip.

Respective functions of any of the device 800 may be implemented, for example, by reading specified software (program) on hardware such as the processor 810 and the memory 820, so that the processor 810 performs computations, controls communication performed by the communication apparatus 840, and controls reading and/or writing of data in the memory 820 and the storage 830.

The processor 810, for example, operates an operating system to control the entire computer. The processor 810 may be constituted by a Central Processing Unit (CPU), which includes interfaces with peripheral apparatuses, a control apparatus, a computing apparatus, a register and the like. For example, the determining unit, the adjusting unit and so on described above may be implemented by the processor 810.

In addition, the processor 810 reads programs (program codes), software modules and data and the like from the storage 830 and/or the communication apparatus 840 to the memory 820, and executes various processes according to them. As for the program, a program causing computers to execute at least a part of the operations described in the above embodiments may be employed. For example, the control unit of the terminal 500 may be implemented by a control program stored in the memory 820 and operated by the processor 810, and other functional blocks may also be implemented similarly.

The memory 820 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 820 may also be referred to as a register, a cache, a main memory (a main storage apparatus) and the like. The memory 820 may store executable programs (program codes), software modules and the like for implementing a method involved in an embodiment of the present disclosure.

The storage 830 is a computer-readable recording medium, and may be constituted, for example, by at least one of a flexible disk, a Floppy® disk, a magneto-optical disk (e.g., a Compact Disc ROM (CD-ROM) and the like, a digital versatile disk, a Blu-ray® disk), a removable disk, a hard driver, a smart card, a flash memory device (e.g., a card, a stick and a key driver), a magnetic stripe, a database, a server, and other appropriate storage media. The storage 830 may also be referred to as an auxiliary storage apparatus.

The communication apparatus 840 is a hardware (transceiver device) performing communication between computers via a wired and/or wireless network, and is also referred to as a network device, a network controller, a network card, a communication module and the like, for example. The communication apparatus 840 may include a high-frequency switch, a duplexer, a filter, a frequency synthesizer and the like to implement, for example, Frequency Division Duplex (FDD) and/or Time Division Duplex (TDD). For example, the transmitting unit, the receiving unit and the like of the terminal 500 described above may be implemented by the communication apparatus 840.

The input apparatus 850 is an input device (e.g., a keyboard, a mouse, a microphone, a switch, a button, a sensor and the like) that receives input from the outside. The output apparatus 860 is an output device (e.g., a display, a speaker, a Light Emitting Diode (LED) light and the like) that performs outputting to the outside. In addition, the input apparatus 850 and the output apparatus 860 may also be an integrated structure (e.g., a touch screen).

Furthermore, the respective apparatuses such as the processor 810 and the memory 820 are connected by the bus 870 that communicates information. The bus 870 may be constituted by a single bus or by different buses between the apparatuses.

Furthermore, the base station and the terminal may comprise hardware such as a microprocessor, a Digital Signal Processor (DSP), an Application Specified Integrated Circuit (ASIC), a Programmable Logic Device (PLD), a Field Programmable Gate Array (FPGA), etc., and the hardware may be used to implement a part of or all of the respective functional blocks. For example, the processor 810 may be installed by at least one of these hardware.

### Variations

In addition, terms illustrated in the present specification and/or terms required for understanding of the present specification may be substituted with terms having the same or similar meaning. For example, a channel and/or a symbol may also be a signal (signaling). Furthermore, the signal may be a message. A reference signal may be abbreviated as an “RS”, and may also be referred to as a pilot, a pilot signal and so on, depending on the standard applied. Furthermore, a component carrier (CC) may also be referred to as a cell, a frequency carrier, a carrier frequency, and the like.

Furthermore, information, parameters and so on described in this specification may be represented in absolute values or in relative values with respect to specified values, or may be represented by other corresponding information. For example, radio resources may be indicated by specified indexes. Furthermore, formulas and the like using these parameters may be different from those explicitly disclosed in this specification.

Names used for parameters and the like in this specification are not limited in any respect. For example, since various channels (Physical Uplink Control Channels (PUCCHs), Physical Downlink Control Channels (PDCCHs), etc.) and information elements may be identified by any suitable names, the various names assigned to these various channels and information elements are not limitative in any respect.

Information, signals and the like described in this specification may be represented by using any of a variety of different technologies. For example, data, instructions, commands, information, signals, bits, symbols, chips, etc. possibly referenced throughout the above description may be represented by voltages, currents, electromagnetic waves, magnetic fields or particles, optical fields or photons, or any combination thereof.

In addition, information, signals and the like may be output from higher layers to lower layers and/or from lower layers to higher layers. Information, signals and the like may be input or output via a plurality of network nodes.

Information, signals and the like that are input or output may be stored in a specific location (for example, in a memory), or may be managed in a management table. Information, signals and the like that are input or output may be overwritten, updated or appended. Information, signals and the like that are output may be deleted. Information, signals and the like that are input may be transmitted to other apparatuses.

Reporting of information is by no means limited to the manners/embodiments described in this specification, and may be implemented by other methods as well. For example, reporting of information may be implemented by using physical layer signaling (for example, Downlink Control Information (DCI), Uplink Control Information (UCI)), higher layer signaling (for example, Radio Resource Control (RRC) signaling, broadcast information (Master Information Blocks (MIBs), System Information Blocks (SIBs), etc.), Medium Access Control (MAC) signaling), other signals or combinations thereof.

In addition, physical layer signaling may also be referred to as L1/L2 (Layer 1/Layer 2) control information (L1/L2 control signals), L1 control information (L1 control signal) and the like. Furthermore, RRC signaling may also be referred to as RRC messages, for example, RRC connection setup messages, RRC connection reconfiguration messages, and so on. Furthermore, MAC signaling may be reported by using, for example, MAC Control Elements (MAC CEs).

Furthermore, notification of prescribed information (for example, notification of “being X”) is not limited to being performed explicitly, and may be performed implicitly (for example, by not performing notification of the prescribed information or by notification of other information).

Decision may be performed by a value (0 or 1) represented by 1 bit, or by a true or false value (Boolean value) represented by TRUE or FALSE, or by a numerical comparison (e.g., comparison with a prescribed value).

Software, whether referred to as “software”, “firmware”, “middleware”, “microcode” or “hardware description language”, or called by other names, should be interpreted broadly to mean instructions, instruction sets, code, code segments, program codes, programs, subprograms, software modules, applications, software applications, software packages, routines, subroutines, objects, executable files, execution threads, procedures, functions and so on.

In addition, software, commands, information, etc. may be transmitted and received via a transport medium. For example, when software is transmitted from web pages, servers or other remote sources using wired technologies (coaxial cables, fibers, twisted pairs, Digital Subscriber Lines (DSLs), etc.) and/or wireless technologies (infrared ray, microwave, etc.), these wired technologies and/or wireless technologies are included in the definition of the transport medium.

The terms “system” and “network” used in this specification may be used interchangeably.

In this specification, terms like “Base Station (BS)”, “wireless base station”, “eNB”, “gNB”, “cell”, “sector”, “cell group”, “carrier” and “component carrier” may be used interchangeably. A base station is sometimes referred to as terms such as a fixed station, a NodeB, an eNodeB (eNB), an access point, a transmitting point, a receiving point, a femto cell, a small cell and the like.

A base station is capable of accommodating one or more (for example, three) cells (also referred to as sectors). In the case where the base station accommodates a plurality of cells, the entire coverage area of the base station may be divided into a plurality of smaller areas, and each smaller area may provide communication services by using a base station sub-system (for example, a small base station for indoor use (a Remote Radio Head (RRH)). Terms like “cell” and “sector” refer to a part of or an entirety of the coverage area of a base station and/or a sub-system of the base station that provides communication services in this coverage.

In this specification, terms such as “Mobile Station (MS)”, “user terminal”, “User Equipment (UE)”, and “terminal” may be used interchangeably. The mobile station is sometimes referred by those skilled in the art as a user station, a mobile unit, a user unit, a wireless unit, a remote unit, a mobile device, a wireless device, a wireless communication device, a remote device, a mobile user station, an access terminal, a mobile terminal, a wireless terminal, a remote terminal, a handset, a user agent, a mobile client, a client, or some other appropriate terms.

Furthermore, the base station in this specification may also be replaced with a terminal. For example, for a structure in which communication between a base station and a terminal is replaced with communication between a plurality of terminals (Device-to-Device, D2D), the respective manners/embodiments of the present disclosure may also be applied. In this case, functions provided by the base station 600 described above may be regarded as functions provided by a terminal. Furthermore, the words “uplink” and “downlink” may also be replaced with “side”. For example, an uplink channel may be replaced with a side channel.

Also, the terminal in this specification may be replaced with a base station. In this case, functions provided by the above terminal 500 may be regarded as functions provided by a base station.

In this specification, specific actions configured to be performed by the base station sometimes may be performed by its upper nodes in certain cases. Obviously, in a network composed of one or more network nodes having base stations, various actions performed for communication with terminals may be performed by the base stations, one or more network nodes other than the base stations (for example, Mobility Management Entities (MMEs), Serving-Gateways (S-GWs), etc., may be considered, but not limited thereto)), or combinations thereof.

The respective manners/embodiments described in this specification may be used individually or in combinations, and may also be switched to use during execution. In addition, orders of processes, sequences, flow charts and so on of the respective manners/embodiments described in this specification may be re-ordered as long as there is no inconsistency. For example, although various methods have been described in this specification with various units of steps in exemplary orders, the specific orders as described are by no means limitative.

The manners/embodiments described in this specification may be applied to systems that utilize Long Term Evolution (LTE), Advanced Long Term Evolution (LTE-A, LTE-Advanced), Beyond Long Term Evolution (LTE-B, LTE-Beyond), the super 3rd generation mobile communication system (SUPER 3G), Advanced International Mobile Telecommunications (IMT-Advanced), the 4th generation mobile communication system (4G), the 5th generation mobile communication system (5G), the 6th generation mobile communication system (6G), Future Radio Access (FRA), New Radio Access Technology (New-RAT), New Radio (NR), New radio access (NX), Future generation radio access (FX), Global System for Mobile communications (GSMS), Code Division Multiple Access 3000 (CDMA 3000), Ultra Mobile Broadband (UMB), IEEE 920.11 (Wi-Fi®), IEEE 920.16 (WiMAX®), IEEE 920.20, Ultra-Wide Band (UWB), Bluetooth® and other appropriate wireless communication methods, and/or next-generation systems that are enhanced based on them.

Terms such as “according to” as used in this specification do not mean “only according to”, unless otherwise specified in other paragraphs. In other words, terms such as “according to” mean both “only according to” and “at least according to”.

Any reference to units with designations such as “first”, “second” and so on as used in this specification does not generally limit the quantity or order of these units. These designations may be used in this specification as a convenient method for distinguishing between two or more units. Therefore, reference to a first unit and a second unit does not imply that only two units may be employed, or that the first unit must precedes the second unit in several ways.

Terms such as “deciding (determining)” as used in this specification may encompass a wide variety of actions. The “deciding (determining)” may regard, for example, calculating, computing, processing, deriving, investigating, looking up (e.g., looking up in a table, a database or other data structures), ascertaining, etc. as performing the “deciding (determining)”. In addition, the “deciding (determining)” may also regard receiving (e.g., receiving information), transmitting (e.g., transmitting information), inputting, outputting, accessing (e.g., accessing data in a memory), etc. as performing the “deciding (determining)”. In addition, the “deciding (determining)” may further regard resolving, selecting, choosing, establishing, comparing, etc. as performing the “deciding (determining)”. That is, the “deciding (determining)” may regard certain actions as performing the “deciding (determining)”.

As used herein, terms such as “connected”, “coupled”, or any variation thereof mean any direct or indirect connection or coupling between two or more units, and may include the presence of one or more intermediate units between two units that are “connected” or “coupled” to each other. Coupling or connection between the units may be physical, logical or a combination thereof. For example, “connection” may be replaced with “access”. As used in this specification, two units may be considered as being “connected” or “coupled” to each other by using one or more electrical wires, cables and/or printed electrical connections, and, as a number of non-limiting and non-inclusive examples, by using electromagnetic energy having wavelengths in the radio frequency region, microwave region and/or optical (both visible and invisible) region.

When terms such as “including”, “comprising” and variations thereof are used in this specification or the claims, these terms, similar to the term “having”, are also intended to be inclusive. Furthermore, the term “or” as used in this specification or the claims is not an exclusive or.

Although the present disclosure has been described above in detail, it should be obvious to a person skilled in the art that the present disclosure is by no means limited to the embodiments described in this specification. The present disclosure may be implemented with various modifications and alterations without departing from the spirit and scope of the present disclosure defined by the recitations of the claims. Consequently, the description in this specification is for the purpose of illustration, and does not have any limitative meaning to the present disclosure.

1. A terminal device comprising:
a receiving unit configured to receive information about spatial filters of a base station;
a control unit configured to determine at least one spatial filter index corresponding to a specific synchronization signal block index according to information about the spatial filters of the base station, wherein the at least one spatial filter index corresponding to the specific synchronization signal block index is generated by using a pseudo-random sequence generator.

2. The terminal device according to claim 1, wherein
the information about the spatial filters of the base station comprises information about an index of a synchronization signal block burst set associated with the spatial filters of the base station and information about indexes of synchronization signal blocks in the synchronization signal block burst set, wherein one synchronization signal block burst set comprises a plurality of synchronization signal blocks.

3. The terminal device according to claim 2, wherein
the receiving unit receives information about a system frame number;
the control unit determines the information about the index of the synchronization signal block burst set according to at least a part of bits in the information about the system frame number.

4. The terminal device according to claim 2, wherein
the information about the spatial filters of the base station further comprises at least one of information about the total number of spatial filters used by the base station and information about the number of spatial filters used by the base station in each synchronization signal block.

5. The terminal device according to claim 1, wherein
the spatial filters of the base station indicate transmission beams of the base station;
the control unit is further configured to beam scan the transmission beams of the base station in a beam scanning period to obtain reference signal reception power of the transmission beams, wherein one beam scanning period comprises a plurality of synchronization signal block burst set periods.

6. The terminal device according to claim 5, wherein
the control unit is further configured to determine a preferred transmission beam according to a transmission beam corresponding to the reference signal reception power higher than a first predetermined threshold and a transmission beam corresponding to the reference signal reception power lower than a second predetermined threshold.

7. The terminal device according to claim 6, wherein
the control unit is further configured to end the beam scanning after determining the preferred transmission beam, regardless of remaining time of a current beam scanning period.

8. A base station, comprising:
a control unit configured to map, in one beam scanning period, at least a part of transmission beams of the base station with at least a part of synchronization signal blocks in the beam scanning period in a hash pattern, wherein the one beam scanning period comprises a plurality of synchronization signal block burst sets and one synchronization signal block burst set comprises a plurality of synchronization signal blocks;
a transmitting unit configured to transmit a specific synchronization signal block using at least one beam corresponding to the specific synchronization signal block, according to a result of the mapping.

9. The base station according to claim 8, wherein
the transmitting unit is further configured to transmit information about spatial filters of the base station, wherein the spatial filters of the base station indicate transmission beams of the base station.

10. The base station according to claim 8, wherein
the control unit is further configured to determine at least one spatial filter index corresponding to a specific synchronization signal block index by using a pseudo-random sequence generator according to information about an index of a synchronization signal block burst set associated with spatial filters of the base station and information about indexes of synchronization signal blocks in the synchronization signal block burst set.
